(19) United States
(12) Patent Application Publication
(10) Pub. No.: US 2006/0232864 A1
(43) Pub. Date: Oct. 19, 2006

(54) BACKLIGHT MODULE

(76) Inventor: Kun-Jung Tsai, Guangdong (CN)

Correspondence Address: NORTH AMERICA INTELLECTUAL PROPERTY CORPORATION, P.O. BOX 506, MERRIFIELD, VA, 22116, US

(21) Appl. No.: 11/308,317

(22) Filed: Mar. 16, 2006

(30) Foreign Application Priority Data
Apr. 15, 2005 (CN) 200510034291.7

(51) Int. Cl. G02B 5/02

(52) U.S. Cl. 359/599; 359/707

(57) ABSTRACT

A backlight module (100) includes a reflection plate (120), a diffuser plate (110), at least one light source (130) arranged between the reflection plate and the diffuser plate, and at least one diverging lens (140) arranged between the at least one light source and the diffusing plate. The present backlight module can decrease thickness of the backlight module, improve uniformity of brightness, and decrease cost.

### FIELD OF THE INVENTION

The present invention relates to backlight modules, and, more particularly, to a direct type backlight module.

### DESCRIPTION OF RELATED ART

Nowadays, liquid crystal materials are widely utilized in various liquid crystal displays (LCDs) having different sizes for different applications, such as TVs, liquid crystal projectors, mobile telephones, personal digital assistants(PDA), etc. Because liquid crystal itself cannot emit light, light sources must be utilized to illuminate liquid crystal for image display. The light sources are called backlight sources since they are usually configured behind liquid crystal panels. A combination of all components behind the liquid crystal panels, including the light sources, is generally referred to as a backlight module. Usually, backlight modules can be classified into edge light backlight modules and direct type backlight modules.

Referring to FIG. 2, a typical direct type backlight module 50 includes a diffuser plate 16, a reflection plate 58 and a number of light sources 14. The diffuser plate 16 is mounted on the reflection plate 58. A reflection chamber 60 is defined between the diffuser plate 16 and the reflection plate 58. The light sources 14 are regularly distributed in the reflection chamber 60. The light sources 14 can be cold cathode fluorescent lamps (CCFL) or light emitting diodes (LED).

In order to fully irradiate an entire region of the diffuser plate 16, the light sources 14 must be spaced a sufficient distance from the diffuser plate 16. As such, the backlight module is unduly bulky in size, and is adverse to miniaturization of the LCD. In addition, due to the high reflectivity of the reflection plate 58, areas of relative brightness are seen at positions on the reflection plate 58 corresponding to the light sources 14. Therefore, the luminance of such backlight modules is uneven, and thereby such backlight modules are unable to satisfy high quality liquid crystal display requirements. One solution is adding more light sources 14 to satisfy a full and even irradiation for the diffuser plate 16. However, more light sources means higher costs. Additionally, more heat will be generated.

What is needed, therefore, is a backlight module with a lower thickness.

### SUMMARY OF INVENTION

A backlight module according to one preferred embodiment includes a reflection plate, a diffuser plate, at least one light source arranged between the reflection plate and the diffuser plate, and at least one diverging lens arranged between the at least one light source and the diffusing plate.

Compared with conventional backlight module, the present light backlight module has following advantages. Because the diverging lens is used, light emitted from the light source is diffused by the diverging lens. Therefore, the light source can uniformly illuminate a larger region of the diffuser plate through the corresponding diverging lens, thickness of the backlight module can be lowered, and the backlight module can satisfy high quality liquid crystal display requirements. The diverging lens also can improve uniformity of brightness. In addition, the amount of the light sources can be decreased. Because the diverging lens is cheaper than the cold cathode fluorescent lamps and the light emitting diodes, thus cost can be decreased by utilizing the diverging lens.

Other advantages and novel features will become more apparent from the following detailed description of present backlight module, when taken in conjunction with the accompanying drawings.

### BRIEF DESCRIPTION OF DRAWINGS

Many aspects of the present backlight module can be better understood with reference to the following drawings. The components in the drawings are not necessarily to scale, the emphasis instead being placed upon clearly illustrating the principles of the present backlight module. Moreover, in the drawings, like reference numerals designate corresponding parts throughout the several views.

FIG. 1 is a schematic, side view of a backlight module in accordance with a preferred embodiment; and

FIG. 2 is a schematic, side view of a typical backlight module.

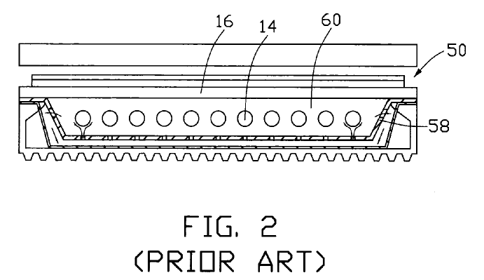

### DETAILED DESCRIPTION

Reference will now be made to the drawings to describe preferred embodiments of the present backlight module, in detail.

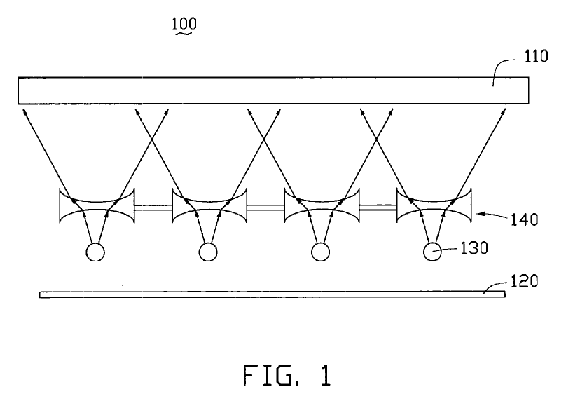

Referring to FIG. 1, a backlight module 100 in accordance with a preferred embodiment is shown. The backlight module 100 mainly includes a diffuser plate 110, a reflection plate 120, at least one light source 130 and at least one diverging lens 140. The at least one light source is arranged between the reflection plate 120 and the diffuser plate 110. The at least one diverging lens 140 is arranged between the at least one light source 130 and the diffuser plate 110. The light source 130 can be a cold cathode fluorescent lamp or light emitting diode.

The diverging lens 140 is arranged adjacent to the light source 130, and is a concave lens. The diverging lens 140 spatially corresponds to the light source 130 so as to scatter light beams from the light source 130. Preferably, the light source is a linear light source with a length thereof being substantially equal to that of the corresponding diverging lens 140.

Compared with conventional backlight module, the present backlight module 100 has following advantages. Because the diverging lens 140 is used, light emitted from the light source 130 is diffused by the diverging lens 140. Therefore, the light source can uniformly illuminate a larger region of the diffuser plate 110 through the corresponding diverging lens 140. That is, it can reduce the distance from the light source 130 to the diffuser plate 110. Thus thickness of the overall backlight module 100 can be lowered, and the backlight module 100 can satisfy needs of high quality liquid crystal display. The diverging lens 140 also can improve uniformity of brightness. In addition, the amount of the light source 130 can be decreased. Because the diverging lens 140 is cheaper than the cold cathode fluorescent lamp and the light emitting diode, thus cost will be decreased by utilizing the diverging lens 140.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A backlight module, comprising:
a reflection plate;
a diffuser plate;
at least one light source arranged between the reflection plate and the diffuser plate; and
at least one diverging lens arranged between the at least one light source and the diffusing plate.

2. The backlight module as claimed in claim 1, wherein the at least one diverging lens is at least one concave lens.

3. The backlight module as claimed in claim 2, wherein the at least one concave lens spatially corresponds to the at least one light source.

4. The backlight module as claimed in claim 3, wherein the at least one light source is the at least one linear light source with a length thereof being substantially equal to that of the corresponding concave lens.

5. The backlight module as claimed in claim 1, wherein the at least one light source is at least one cold cathode fluorescent lamp.

6. The backlight module as claimed in claim 1, wherein the light source is at least one light emitting diode.
